(19) United States
(12) Patent Application Publication
(10) Pub. No.: US 2003/0102256 A1
(43) Pub. Date: Jun. 5, 2003

(54) Combination tap with external water purifier

(76) Inventor: Toshio Takagi, Kitakyushu-shi (JP)

Correspondence Address: ARMSTRONG,WESTERMAN & HATTORI, LLP, 1725 K STREET, NW, SUITE 1000, WASHINGTON, DC, 20006, US

(21) Appl. No.: 10/312,552

(22) PCT Filed: Mar. 8, 2001
(86) PCT No.: PCT/JP01/01827

(30) Foreign Application Priority Data
Aug. 8, 2000 (JP) 2000-240476

(51) Int. Cl. B01D 35/04

(52) U.S. Cl. 210/101; 210/424; 210/449; 137/801

(57) ABSTRACT

A combination tap with external water purifier capable of preventing unwanted bacteria from breeding by washing a system on purified water side including the interior of the water purifier and pipes across the water purifier when raw water is used and also capable of selecting any delivery mode, comprising a combination stop valve mixing hot water with water and forming a main valve, the water purifier disposed on the outside of the combination tap on the downstream side of the combination stop valve so as to purify raw water and having flow paths for purified water and raw water, and a water quality switching valve disposed on the downstream side of the water purifier and allowing either of the purified water and raw water to flow to the delivery side.

### TECHNICAL FIELD

The present invention relates to a combination tap with an external water purifier which is used in a kitchen or a cuisine, and has an ability of purifying water and/or hot water delivered at a time of using.

### BACKGROUND OF ART

In conventional, in the combination tap having a water quality purifying ability for the water, hot water or mixed water between water and hot water (hereinafter, simply refer to the mixed water) which is used in the kitchen or the cuisine and delivered, there are, for example, the combination tap with an external water purifier described in Japanese Patent Application Laid-Open No. 10-61797, No. 8-151668, No.7-98068 and the like.

Each of these combination taps with an external water purifier is constructed such as to branch a water stream before the mixed water reaches the water purifier so as to deliver raw water in one side, and flow the water into the water purifier for purifying the mixed water and deliver the water after purifying the water quality in the other side.

Further, in the matter of the delivery state, the raw water is delivered by shower, and the purified water is delivered in a straight manner.

[Problem of Prior Art]

In the conventional combination tap with an external water purifier of this kind, pipes are connected so that a flow passage formation is branched in front of the water purifier, the structure is not made such that an interior portion of the water purifier, front and rear pipes and the like are cleaned by the raw water having a sterilizing effect. Accordingly, the flow passage of the purified water is polluted with time due to breeding of saprophytic bacteria, and the purified water flow passage becomes in an unhygienic state.

Further, since the delivery state is set such that the raw water is delivered by the shower and the purified water is delivered in the straight manner, and the structure is made such that the other states can not be selected, inconvenience is given to such operations as for delivering the purified water by the shower so as to easily wash away at a time of cleaning table wares, delivering the raw water so as to take the raw water into a vessel having a narrow inlet and the like.

### DISCLOSURE OF THE INVENTION

The present invention is made for the purpose of solving the problems mentioned above in the prior art. A technical object set for that is to provide a combination tap with an external water purifier which can prevent the breeding of the saprophytic bacteria by cleaning systems in a water purifying side including an interior portion of the water purifier, front and rear pipes and the like at a time of using raw water, and can optionally select a delivery state.

As means specifically constructed so as to solve the above problems, a combination tap with an external water purifier according to claim 1 of the present invention is comprising: a water mixing and stop valve which mixes hot water and water and forms a main cock; a water purifier which is arranged in a downstream side of the water mixing and stop valve and in an external portion of the combination tap so as to purify raw water, and has flow passages for purified water and the raw water; a water quality switching valve which is arranged in a downstream side of the water purifier and flows out any one of the purified water and the raw water to a delivery side; and a purifier surface from which the raw water goes into the purifying material at a time of using the purified water as a part of the raw water flow passage at a time of using the raw water.

According to this construction, it is possible to purify the mixed water in which a temperature is optionally set, it is possible to further deliver the mixed water via the water quality switching valve, and it is possible to wash away contamination which is filtered during the purified water delivery and accumulated in the water purifier, at a time of delivering the raw water, whereby it is possible to prevent the saprophytic bacteria from breeding. And, since the water purifier is constructed separately from the combination tap, a size of the water purifier is not limited, the contents of purifying material can be made various, or it is possible to set an amount of the purifying material or the like to a proper amount, and it is possible to effectively remove a harmful substance such as trihalomethanes or the like. Further, since the purifier has a surface which the raw water goes into the purifying material at a time of using the purified water as a part of the raw water flow passage at a time of using the raw water, it is possible to achieve a cleaning effect of flowing out the contamination accumulated on the surface of the purifying material at a time of using the purified water to an external portion of the combination tap on the basis of the stream of the raw water, it is possible to prevent clogging and reduction in a purifying performance, and it is possible to maintain the water purifying effect without reducing.

A combination tap with an external water purifier according to claim 2 is characterized in that a delivery side antibacterial material is provided in a downstream side of the water quality switching valve. Accordingly, it is possible to disinfect or sterilize the saprophytic bacteria going into from the delivery port side by the delivery side antibacterial material, thereby capable of preventing the saprophytic bacteria from breeding.

A combination tap with an external water purifier according to claim 3 is characterized in that a delivery switching valve which is arranged in a downstream side of the water quality switching valve and switches a delivery state to a shower delivery state and a straight delivery state. Accordingly, both of the delivered purified water and raw water can be delivered in accordance with any one state of the shower delivery state and the straight delivery state.

A combination tap with an external water purifier according to claim 4 is characterized in that a branch port into the other equipment is provided in a lower end portion of a main body in the water mixing and stop valve. Accordingly, it is possible to supply a necessary amount of hot water or water for a dish washing machine or the like via the branch port.

A combination tap with an external water purifier according to claim 5 is characterized in that the water quality switching valve is constituted by a flow passage switching valve having a push-button operation part. Accordingly, it is possible to easily switch the water between the purified water and the raw water through one-touch operation, which makes it possible to achieve the combination tap having a high operability.

A combination tap with an external water purifier according to claim 6 is characterized in that the delivery switching valve is constituted by a delivery switching valve having a lever-type operation portion. Accordingly, both of the purified water and the raw water can be easily switched into the shower delivery state and the straight delivery state, and it is possible to switch the delivery state with an improved operability.

A combination tap with an external water purifier according to claim 7 is characterized in that the delivery side antibacterial material is constituted by a sintered magnetic material provided with an amorphous membrane layer on a surface. Accordingly, this allows to reinforce the disinfecting effect by an application of a magnetic force as well as the antibacterial material itself has the water purifying function and the disinfecting function, whereby it is possible not only to disinfect the saprophytic bacteria infiltrating from the delivery port, but also to effectively disinfect the saprophytic bacteria breeding within the purifying material used in the water purifier. Therefore, it is possible to further improve the water quality of the delivered purified water.

### BRIEF DESCRIPTION OF THE DRAWINGS

FIG. 1 is a system schematic view which shows a combination tap with an external water purifier according to the present invention;

FIG. 2 is a side elevation cross sectional view which shows a first embodiment of the combination tap with a external water purifier according to the present invention;

FIG. 3 is a front elevation cross sectional view which shows the first embodiment;

FIG. 4 is a horizontal cross sectional view (a view taken along the line A-A in FIG. 3) which shows a structure of a lower cross section of a main portion in the combination tap according to the first embodiment;

FIG. 5 are horizontal cross sectional views which show a valve portion of a hot water and combination tap according to the first embodiment, in which (A) is a horizontal cross sectional view which shows a water delivering time, (B) is a horizontal cross sectional view which shows a hot water delivering time, (C) is a horizontal cross sectional view which shows a water and hot water mixture delivering time, and (D) is a horizontal cross sectional view which shows a valve closing state;

FIG. 6 is a plan cross sectional view (a view taken along the line F-F in FIG. 7) which shows a flow passage switching valve according to the first embodiment in a state of delivering raw water;

FIG. 7 is a side elevation cross sectional view (a view taken along the line C-C in FIG. 6) which shows the flow passage switching valve according to the first embodiment at a center position in the state of delivering the raw water;

FIG. 8 is a side elevation cross sectional view (a view taken along the line D-D in FIG. 6) which shows the raw water delivering state of the flow passage switching valve according to the first embodiment at a position of a raw water side shutoff valve;

FIG. 9 is a side elevation cross sectional view (a view taken along the line E-E in FIG. 6) which shows the raw water delivering state of the flow passage switching valve according to the first embodiment at a position of a purified water side shutoff valve;

FIG. 10 is a plan cross sectional view (a view taken along the line J-J in FIG. 11) which shows the flow passage switching valve according to the first embodiment in a state of delivering the purified water;

FIG. 11 is a side elevation cross sectional view (a view taken along the line G-G in FIG. 10) which shows the flow passage switching valve according to the first embodiment at a center position in the state of delivering the purified water;

FIG. 12 is a side elevation cross sectional view (a view taken along the line H-H in FIG. 10) which shows the purified water delivering state of the flow passage switching valve according to the first embodiment at a position of the raw water side shutoff valve;

FIG. 13 is a side elevation cross sectional view (a view taken along the line I-I in FIG. 10) which shows the purified water delivering state of the flow passage switching valve according to the first embodiment at a position of the purified water side shutoff valve;

FIG. 14 is a side elevation cross sectional view which shows a second embodiment of the combination tap with the external water purifier according to the present invention; and

FIG. 15 is a front elevation cross sectional view which shows the second embodiment.

### BEST MODE FOR CARRYING OUT THE INVENTION

In the following embodiments in the present invention, a description will be given in detail of a case of a combination tap with an external water purifier in which each of a water mixing and stop valve, a water quality switching valve and a delivery switching valve can independently operate.

In this case, the embodiments are particularly described for the purpose of well understanding a gist of the invention, and do not limit the contents of the invention except being especially defined.

[System Construction]

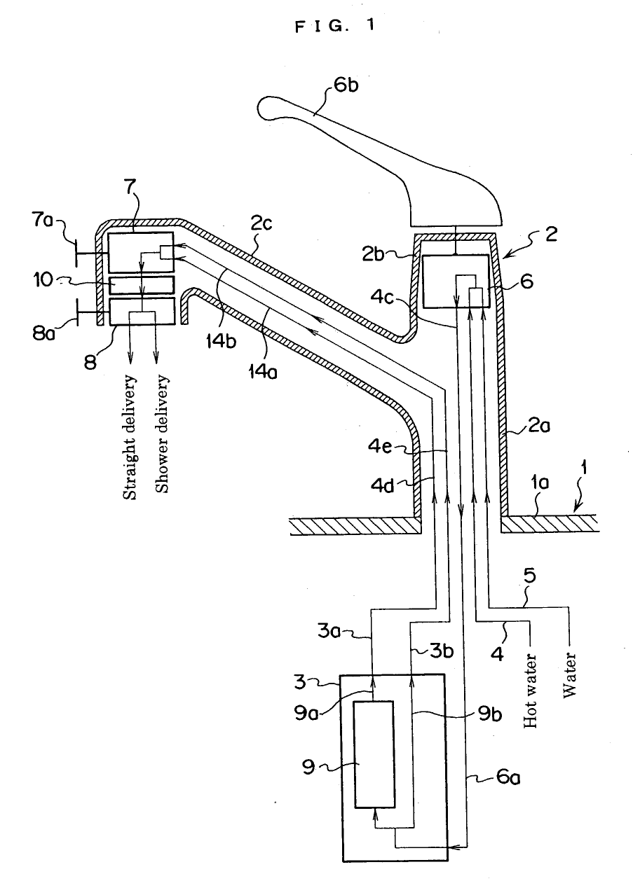

As shown in FIG. 1, a main body 2a of a combination tap 2 is provided so as to protrude to an upper portion of a top panel la in a kitchen cabinet 1. A water purifier 3 is arranged in a lower side from the top panel 1a. A pipe 4 for hot water and a pipe 5 for water are respectively connected to an inflow side of a hot water and water mixing and stop valve 6 which is assembled in an upper end portion 2b of the main body 2a. A connection portion in an outflow side of the mixed water is connected to a connection portion in an inflow side of the water purifier 3, by a pipe 6a for exclusive use of the mixed water. A connection portion in a purified water outflow side of the water purifier 3 is connected to a connection portion in a purified water inflow side of a water quality switching valve 7 which is assembled in an outflow end portion 2c of the main body 2a, by a pipe 3a for purifying the water. A connection portion in a raw water outflow side of the water purifier 3 is connected to a connection portion in a raw water inflow side of the water quality switching valve 7, by a pipe 3b for the raw water. An outflow side of the water quality switching valve 7 is connected to an inflow side of a delivery switching valve 8 via an installing portion of a delivery side antibacterial material 10. One of outflow ports in the delivery switching valve 8 is formed as a shower delivery port, and the other is formed as a straight delivery port.

In an interior portion of the water purifier 3, the connection portion in the inflow side to which the pipe 6a is connected is branched, one forms a purifying passage 9a which passes through a purifying cartridge 9 and purifies the water quality, and the other forms a raw water passage 9b which does not pass through the purifying cartridge 9, whereby branch passages for the mixed water are formed.

The hot water and water mixing and stop valve 6 which is assembled in the upper end portion 2b of the main body 2a of the combination tap 2, and the water quality switching valve 7 and the delivery switching valve 8 which are assembled in the outflow end portion 2c of the main body 2a are respectively structured such that a lever 6b corresponding to an operation portion for the hot water and water mixing and stop vale 6, and an operation portion 7a and an operation portion 8a are arranged in an external portion of the combination tap 2, whereby a switching operation can be performed from the external portion of the combination tap 2.

The hot water and water mixing and stop valve 6 is structured such that a water stop, a water supply and a flow amount regulation are performed by moving one lever 6b which is mounted to a valve shaft protruding out from the upper end portion 2b of the main body 2a and forms the operation portion, upward and downward, and a temperature regulation of the mixed water is performed by turning the lever 6b rightward and leftward.

The water quality switching valve 7 switches the delivery water quality between the purified water and the raw water by operating the operation portion 7a constituted by a push button, a lever or the like which protrudes out from the outflow end portion 2c of the main body 2a.

The delivery switching valve 8 is arranged in an immediately near downstream side of the water quality switching valve 7 provided in the outflow end portion 2c of the main body 2a, and switches a delivery state between a shower delivery state and a straight delivery state by operating the operation portion 8a constituted by a lever, a knob or the like which protrudes out to an outer surface side of a leading end portion of the outflow end portion 2c.

[Embodiments]

A detail description will be given of two embodiments in connection with the flow passage formation within the water purifier.

[First Embodiment]

A description will be particularly given below of a case that an internal flow passage of the water purifier employs a raw water flow passage arranged in an outer peripheral side of the purifying cartridge 9.

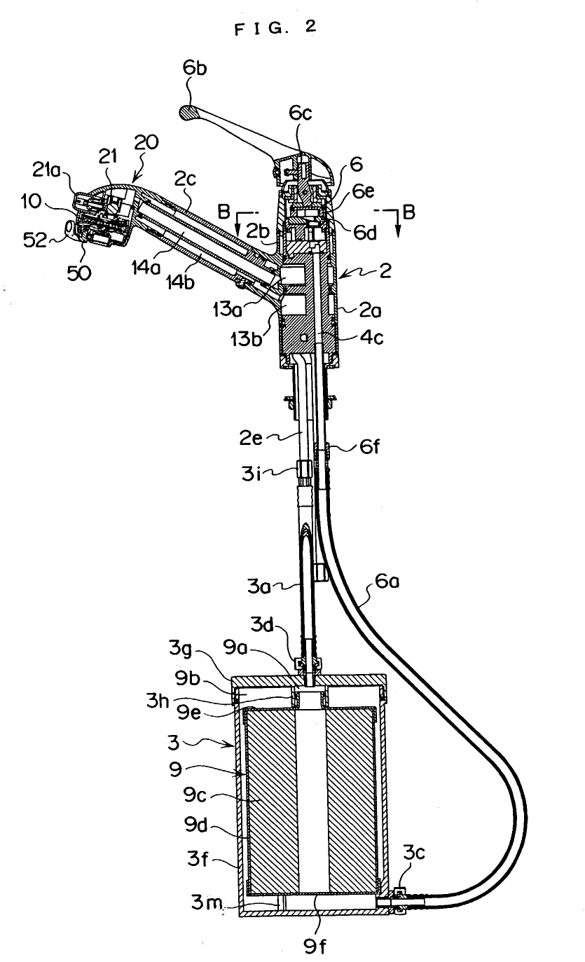

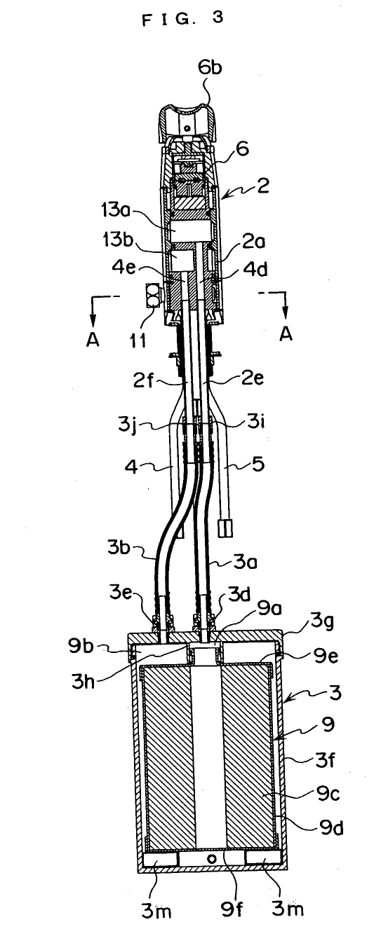

As shown in FIGS. 2 and 3, there is provided the hot water and water mixing and stop valve 6 which mixes the hot water with the water and performs the water stop, the water supply and the flow amount regulation by turning the lever 6b upward and downward and rightward and leftward, as the combination tap 2; a push-button flow passage switching valve 21 which switches the delivery state between the raw water state and the purified water state as the water quality switching valve 7; and a lever-type delivery switching valve 50 which switches the delivery state between the shower delivery state and the straight delivery state as the delivery switching valve 8. Further, the water purifier 3 purifying the mixed water is arranged below the main body 2a of the combination tap 2. The hot water pipe 4 and the water pipe 5 are trailed, upper end portions of the pipes 4 and 5 are respectively connected to the inflow sides of the hot water and water mixing and stop valve 6. A connection portion 6f in an outflow side of the mixed water is connected to a connection portion 3c in an inflow side of the water purifier 3 by the pipe 6a exclusive for the mixed water. A connection portion 3d in a purified water outflow side of the water purifier 3 is connected to a connection portion 3i of a flow passage which is communicated with a purified water inflow side of the flow passage switching valve 21 assembled in the outflow end portion 2c of the main body 2a by the purified water pipe 3a. A connection portion 3e in a raw water outflow side of the water purifier 3 is connected to a connection portion 3j of a flow passage which is communicated with a raw water inflow side of the flow passage switching valve 21 by the raw water pipe 3b. The delivery side antibacterial material 10 for preventing the saprophytic bacteria from breeding is arranged in an outlet port of the flow passage switching valve 21. An outflow side of the flow passage switching valve 21 is connected to an inflow side of the delivery switching valve 50 via an installing portion of the delivery side antibacterial material 10, one of outflow ports of the delivery switching valve 50 is formed as a shower delivery port, and the other is formed as a straight delivery port.

In an inner portion of the water purifier 3, as shown in FIGS. 2 and 3, there is formed from the connection portion 3c in the inflow side to which the pipe 6a is connected, a purified water flow passage 9a which passes through the purifying cartridge 9 from an outer peripheral side toward a center portion, purifies the water quality and flows out to the external portion of the water purifier 3 from the connection portion 3d in the purified water outflow side in one side, and a raw water flow passage 9b which passes through an outer peripheral side of the purifying cartridge 9 and flows out from the connection portion 3e in the raw water outflow side to the external portion of the water purifier 3, thereby forming a purified water and raw water branching passage.

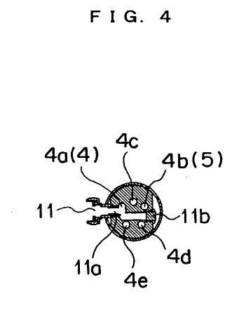

In a lower portion (a lower end portion of the main body 2a) in which the hot water and water mixing and stop valve 6 is provided in the main body 2a of the combination tap 2, as shown in FIG. 4, there is provided a branch port 11 which is connected to the other equipment such as a dish washing machine or the like. A flow passage 11a communicated with this branch port 11 is positioned in an upstream side of the hot water and water mixing and stop valve 6, and is connected to the hot water pipe 4 or the water pipe 5, whereby the hot water or the water can be supplied to the other equipment without relation to the state of the combination tap 2. Further, when a lid 11b provided in an opposite end portion to an end portion having the branch port 11 of the flow passage 11a is taken off, a new branch port can be provided in this end portion. Accordingly, the other equipment can be connected in any side of left side and right side of the combination tap 2.

On a transverse surface at a position of the branch port 11, in addition to the flow passage 11a and the flow passage 4a, there can be perforated a water flow passage 4b, a hot water and water mixed water flow passage 4c, a purified water flow passage 4d and a raw water flow passage 4e on a concentric circular arc with a center axis of the hot water and water mixing and stop valve 6 with a suitable interval. The water flow passage 4b is perforated in a vertical direction and is provided in parallel to the flow passage 4a with an interval. The hot water and water mixed water flow passage 4c is disposed at a middle position between the flow passage 4a and the flow passage 4b and is positioned on the concentric circular arc with the center axis of the hot water and water mixing and stop valve 6. The purified water flow passage 4d and the raw water flow passage 4e are formed downward the water purifier 3 at positions in an opposite side with respect to the flow passage 11a to the side in which the flow passages 4a to 4c are formed.

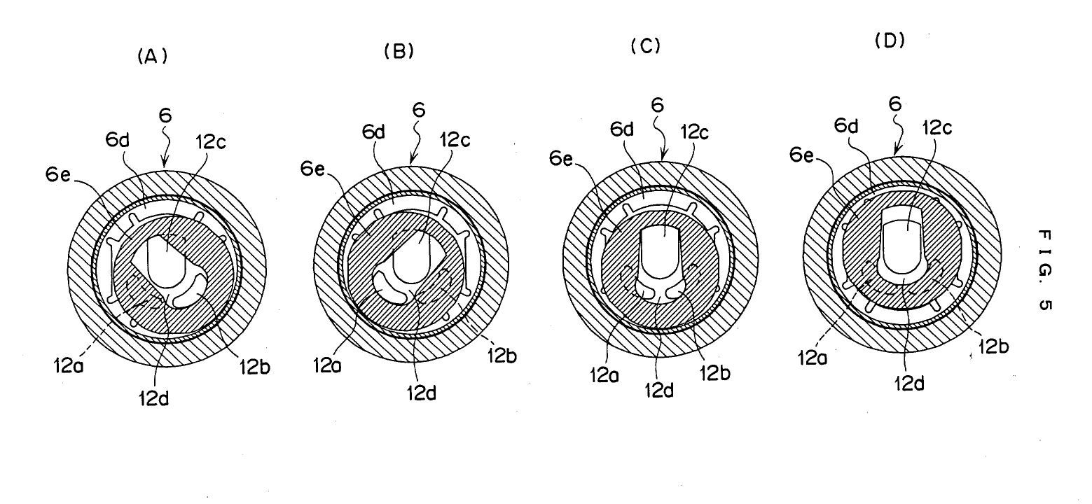

A valve portion of the hot water and water mixing and stop valve 6 is formed in such a manner as to be operated by a pawl member 6c mounted to the lever 6b. As shown in FIG. 5, a lower surface of a movable member 6e is brought into contact with an upper surface of a fixed member 6d fixed within the tap, and is stacked so that the movable member 6e can two-dimensionally move on the fixed member 6d. A lower end of the pawl member 6c is fitted to a center portion of the movable member 6e. Accordingly, the structure is made such that a motion of the lever 6b is transmitted to the movable member 6e via the pawl member 6c.

A hot water flow passage 12a and a water flow passage 12b are perforated in a middle portion between a center portion and a peripheral portion in the fixed member 6d, and a mixed water flow passage 12c having a substantially rectangular cross section is perforated from the center portion of the fixed member 6d close to the hot water flow passage 12a and the water flow passage 12b. Further, a controlling non-through hole 12d is pieced in the movable member 6e. The controlling non-through hole 12d is formed in an approximately similar shape to the mixed water flow passage 12c and longer in a longitudinal direction, and is formed wider in a width direction on a side where the hot water flow passage 12a and the water passage 12b are arranged.

Further, a relative positional relationship between the fixed member 6d and the movable member 6e is set as follows. In the case of lifting up the lever 6b so as to achieve a state in which any one of the hot water, the water and the mixed water is out and fully turning the lever 6b in a counterclockwise direction, a leading end portion of the hole 12d in the movable member 6e overlaps the water flow passage 12b perforated in the fixed member 6d (refer to FIG. 5A). On the contrary, in the case of fully turning the lever 6b in a clockwise direction, a leading end portion of the hole 12d in the movable member 6e overlaps the hot water flow passage 12a perforated in the fixed member 6d (refer to FIG. 5B). At a middle position between the above cases, the leading end portion of the hole 12d in the movable member 6e overlaps a part of the hot water flow passage 12a and a part of the water flow passage 12b (refer to FIG. 5C). In a state in which the lever 6b is lifted up to an uppermost portion, the hot water flow passage 12a, the water flow passage 12b, or a part of the hot water flow passage 12a and a part of the water flow passage 12b respectively overlap a whole area of the hot water flow passage 12a, a whole area of the water flow passage 12b, or about half of the hot water flow passage 12a and about half of the water flow passage 12b. When pressing down the lever 6b to a lowermost portion, the position of the movable member 6e is shifted on the fixed member 6d, and the hole 12d of the movable member 6e comes off from the hot water flow passage 12a and the water flow passage 12b in the fixed member 6d so as to close the flow passage and stop the water (refer to FIG. 5D).

The purified water pipe 3a and the raw water pipe 3b from the water purifier 3 are respectively connected to the connection portions 3i and 3j of the connection pipes 2e and 2f which are independently provided in the lower end of the main body 2a, and are communicated with the purified water flow passage 4d and the raw water flow passage 4e within the main body 2a of the combination tap 2.

The flow passage within the main body 2a of the combination tap 2 is formed by arranging a purified water side space 13a connected to the purified water flow passage 4d and a raw water side space 13b connected to the raw water flow passage 4e in an axial direction as shown in FIGS. 2 and 3, and is interconnected with each of a purified water flow passage 14a of an inner flow passage and a raw water flow passage 14b of an outer flow passage which are formed in a base portion of the outflow end portion 2c formed as a double tube from the respective spaces 13a and 13b.

A head portion 20 formed in a shower head shape as a delivery end portion is mounted to a leading end of the outflow end portion 2c in which the inner flow passage of the double tube is set to the purified water flow passage 14a and the outer flow passage is set to the raw water flow passage 14b.

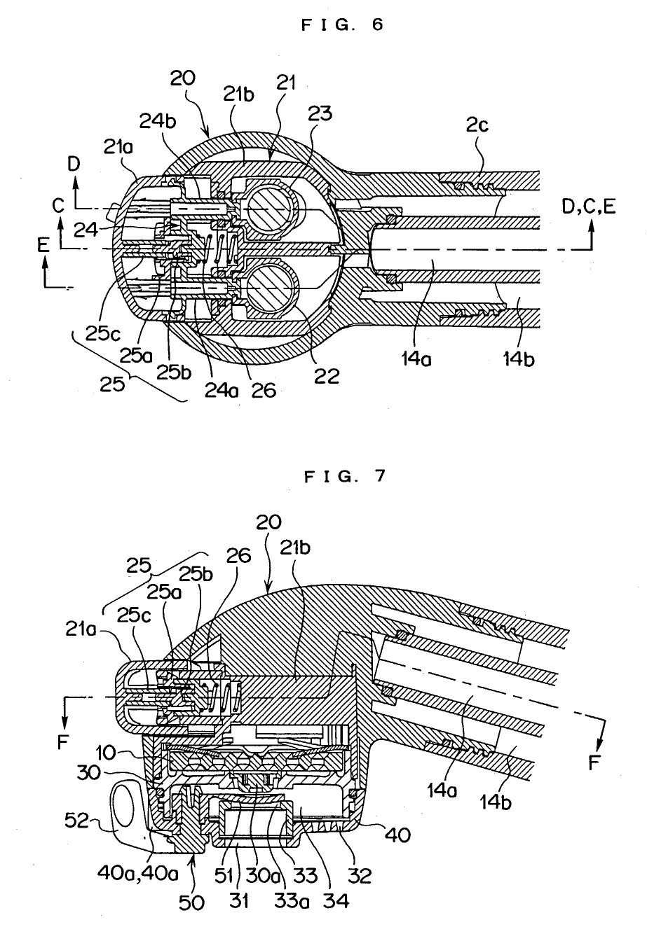

As shown in an enlarged partial cross sectional view in FIGS. 6 to 13, a push-button flow passage switching valve 21 is assembled in the head portion 20, the delivery side antibacterial material 10 is arranged in a downstream side of the flow passage switching valve 21, a partition plate 30 provided with an opening portion in a center portion is arranged in a downstream side of a position at which the delivery side antibacterial material 10 is arranged, and a shower plate 40 positioning a straight delivery port 31 is detachably provided directly below the opening portion of the partition plate 30.

A lever-type delivery switching valve 50 is assembled in the shower plate 40, and shower delivery ports 32 are formed in a periphery of the straight delivery port 31 perforated in the center portion in the shower plate 40. This shower plate 40 forms a lid member in a lower end side of the head portion 20, makes it easy to attach and replace the flow passage switching valve 21 and the delivery side antibacterial material 10 by attaching and detaching the shower plate 40 and also make it easy to attach and detach the delivery switching valve 50 with and from the head portion 20.

The flow passage switching valve 21 protrudes a push button 21a corresponding to an operation member from a surface just opposite to the connection side surface to the outflow end portion 2c, and is structured such that the switching between the purified water and the raw water can be achieved only by pressing the push button 21a from the external portion.

Further, the flow passage switching valve 21 is provided with two shutoff valves comprising a purified water side shutoff valve 22 and a raw water side shutoff valve 23, and is formed in such a manner that two shutoff valves comprising the purified water side shutoff valve 22 and the raw water side shutoff valve 23 can be simultaneously operated by one push button 21a. In these purified water side shutoff valve 22 and the raw water side shutoff valve 23, opening positions of valve seats formed in the respective valves are arranged in a relatively shifted manner with respect to a moving direction of the push button 21a so that any one valve is closed in accordance with a pressing amount of the push button 21a.

The purified water flow passage 14a and the raw water flow passage 14b which are formed in the inner portion of the outflow end portion 2c are respectively connected to inlets (valve inlet portions) of the purified water side shutoff valve 22 and the raw water side shutoff valve 23 which are assembled in the head portion 20, and one flow passage through which both of the purified water and the raw water pass is formed in the downstream side of the purified water side shutoff valve 22 and the raw water side shutoff valve 23.

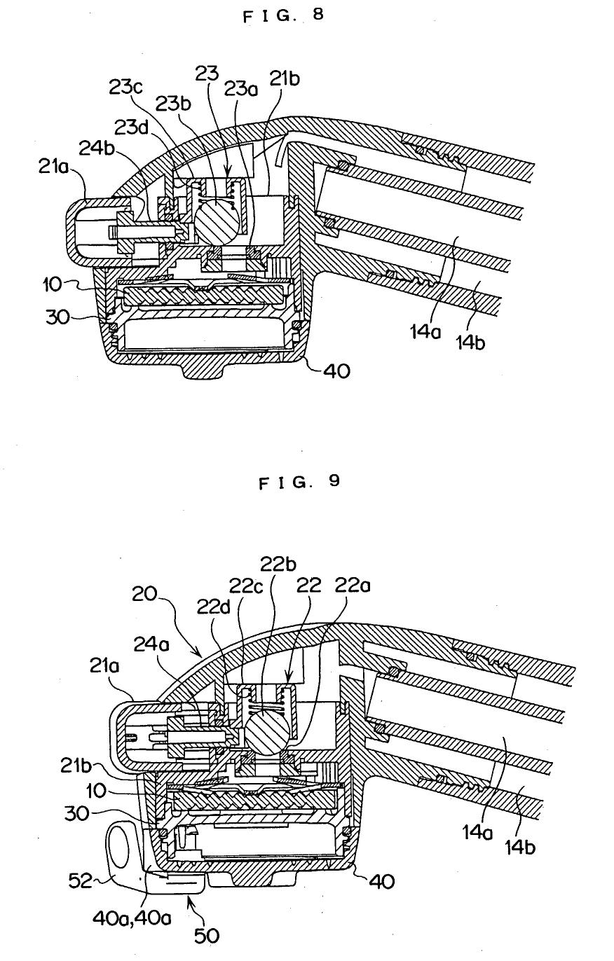

In the raw water side shutoff valve 23, a position of a valve seat 23a formed in a ring-like body is defined so that the valve is opened in accordance with a shallow pressing amount (FIG. 8) of the push button 21a. When pressing the push button 21a to a position of a deep pressing amount (FIG. 12), a valve body 23b formed in a rigid spherical shape such as a steel ball or the like closes a hole portion in the valve seat 23a formed in the ring-like body from an upstream side, whereby the valve is closed. In this raw water side shutoff valve 23, a box-like valve body supporting member 23c is formed, a coil spring 23d and the valve body 23b are received within the valve body supporting member 23c, and the valve body 23b is pressed toward the valve seat 23a by a pressing force of the coil spring 23d.

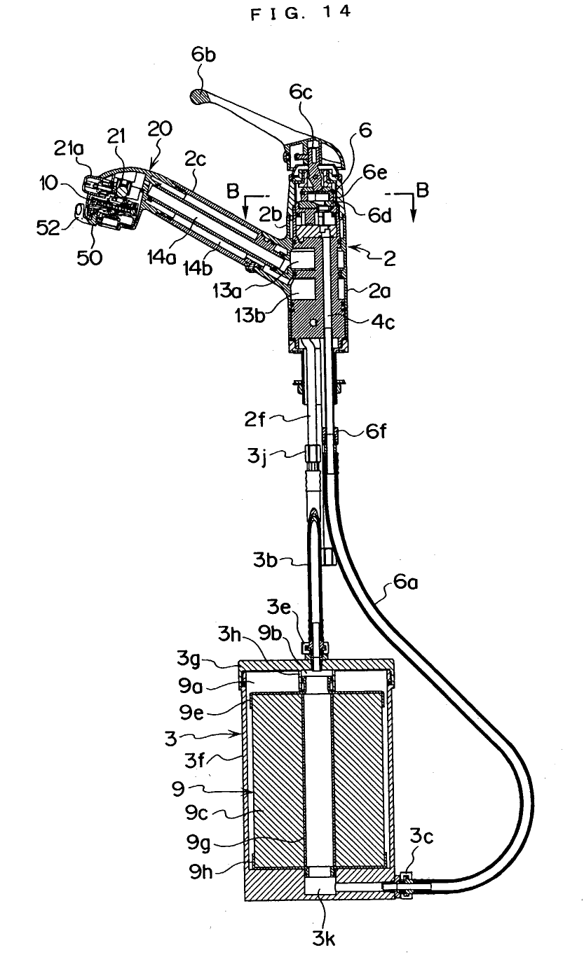

Further, in the purified water side shutoff valve 22, a position of a valve seat 22a formed in a ring-like body is defined so that the valve is closed in accordance with a shallow pressing amount (FIG. 9) of the push button 21a. When pressing the push button 21a to a position of a deep pressing amount (FIG. 13), a valve body 22b formed in a rigid spherical shape such as a steel ball or the like is pushed out to a side direction from a hole portion in the valve seat 22a formed in the ring-like body, whereby the valve is opened. In this purified water side shutoff valve 22, a box-like valve body supporting member 22c is formed, a coil spring 22d and the valve body 22b are received within the valve body supporting member 22c, and the valve body 22b is pressed toward the valve seat 22a by a pressing force of the coil spring 22d.

The purified water side shutoff valve 22 and the raw water side shutoff valve 23 are arranged in such a manner that the opening positions of the valve seats are relatively shifted. Accordingly, even in the case that the valve body 22b enters into the hole portion of the valve seat 22a in the purified water side shutoff valve 22 so as to be at a position (FIG. 9) where the valve is closed, when the pressing amount of the push button 21a is shallow, the raw water side shutoff valve 23 becomes in a state in which the valve body 23b stops at an edge portion positioned toward the push button 21a of the hole portion in the valve seat 23a (FIG. 8), and the valve body 23b does not reach the hole portion of the valve seat 23a, so that the state in which the valve is opened is maintained. Further, on the contrary, even in the case that the valve body 23b enters the hole portion of the valve seat 23a in the raw water side shutoff valve 23 so as to be at a position (FIG. 12) where the valve is closed, when the pressing amount of the push button 21a is deep, the purified water side shutoff valve 22 becomes in a state in which the valve body 22b is pushed up to an edge portion positioned in the side of the outflow end portion 2c of the hole portion in the valve seat 22a (FIG. 13), and the valve body 22b comes off from the hole portion of the valve seat 22a, so that the state in which the valve is opened is maintained.

In the downstream side of the flow passage switching valve 21, there is arranged the partition plate 30 formed in such a manner that a center portion is opened, and a collecting and passing member 30a is provided in the opening, whereby the mixed water collects into the center portion from the peripheral portion and flows out from right above the straight delivery port 31 in the downstream side. A space capable of receiving the delivery side antibacterial material 10 is formed in the upper surface side of the partition plate 30. A straight delivery passage 33 forming a flow passage to the straight delivery port 31 is provided in a directly closer downstream side which has a slight gap from the collecting and passing portion 30a provided in the partition plate 30 in such a manner as to stand from the shower plate 40. An inlet port 33a is open to an upper end of the straight delivery passage 33. A valve body 51 of a delivery switching valve 50 is arranged in a gap between the collecting and passing member 30a and the inlet portion 33a of the straight delivery passage 33, thereby being formed in such a manner that an upper end surface of the inlet portion 33a in the straight delivery passage 33 can be closed by the valve body 51. A space formed in an outer peripheral side of the straight delivery passage 33 is set to a shower delivery passage 34 corresponding to an inlet portion of the shower delivery port 32. A valve shaft of the delivery switching valve 50 passes through the shower plate 40 and the valve body 51 is received within the shower delivery passage 34. The valve body 51 is axially supported in such a manner as to freely rotate around the valve shaft. Thus, the valve body 51 is provided in the gap between the collecting and passing member 30a and the inlet portion 33a of the straight delivery passage 33 in such a manner as to freely come in and out.

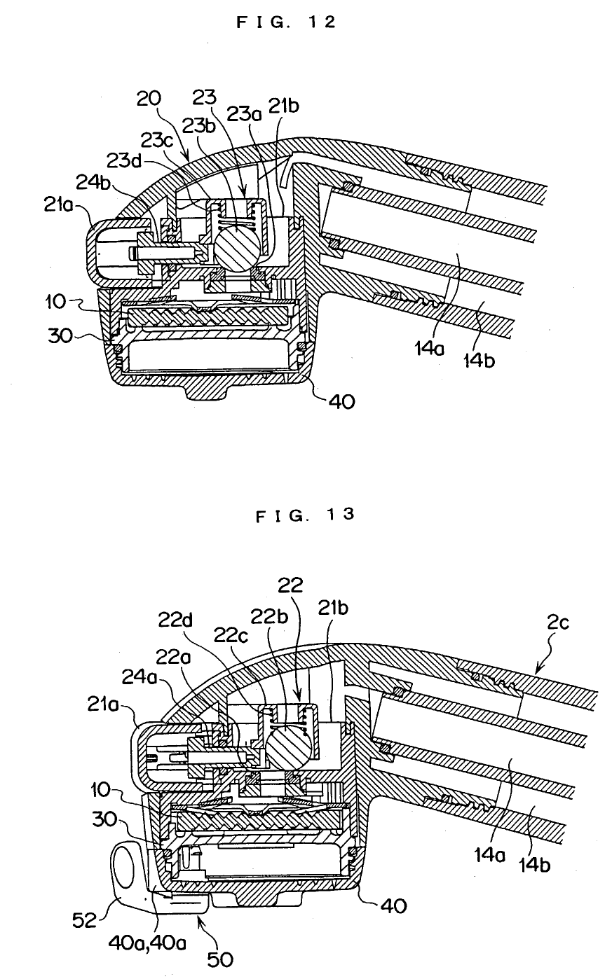

The delivery switching valve 50 is structured, as shown in FIGS. 7 and 11, such that a shaft portion which is integrally formed in a switching lever 52 corresponding to the operation member is connected to an end portion of the valve body 51 which is provided in the inner portion through the shower plate 40, and the valve body 51 comes in and :out the upper end side of the straight delivery passage 33, thereby branching the flow passage of the mixed water into any of the straight delivery port 31 and the shower delivery port 32. Accordingly, the valve body 51 provided within the shower plate 40 is operated by handling the switching lever 52 from the external portion of the shower plate 40, whereby the straight delivery state and the shower delivery state can be switched.

The delivery switching valve 50 is structured such that the valve body 51 is formed in a curved plate shape having a shallow recess surface on a top surface. The switching lever 52 is structured such that a knob portion capable of being pinched by fingers is formed in one end side, and a shaft portion rotatably provided through the shower plate 40 is integrally formed in another end side. A mounting end of the valve body 51 is detachably fitted and attached to an end portion positioned within the shower delivery passage 34 of the shaft portion in which the switching lever 52 is formed at one end.

An operating mechanism for operating each of the shutoff valves 22 and 23 of the flow passage switching valve 21 by the push button 21a is constituted by a valve box 21b, a double throw push rod 24, a cam mechanism 25 and a coil spring 26. The valve box 21b receives both of the shutoff valves 22 and 23, forms an operating mechanism supporting frame body in a front surface wall portion and mounts each of the valve seats 22a and 23a to a flat surface portion. The double throw push rod 24 is integrally provided with two push rods 24a and 24b structured such that the valve body 22b and the valve body 23b can simultaneously move at a time of being engaged with the respective valve body supporting members 22c and 23c and being pushed by the push button 21a. The cam mechanism 25 is constructed by combining three constituting parts for changing a moving distance of this double throw push rod 24, that is, a switching ring 25a, a first switching piece 25b and a second switching piece 25c. The coil spring 26 applies a force in a pushing back side to the double throw push rod 24.

The delivery side antibacterial material 10 provided in the downstream side of the flow passage switching valve 21 is structured such that a ferrite sintered magnetic body having a ferric oxide as a main raw material is set to a parent body, and an amorphous membrane layer having a ferric oxide, a cobalt oxide, a lithium carbonate or the like as a main raw material is provided on a surface of the parent body. The delivery side antibacterial material 10 itself has a water purifying function and a disinfecting function, reinforces a disinfecting effect on the basis of the operation of the magnetic force, effectively disinfects or sterilizes the saprophytic bacteria breeding in an inner portion of an active carbon corresponding to a main component of the purifying cartridge 9 within the water purifier 3, and improves a quality of the delivered water. Further, the delivery side antibacterial material 10 can be assembled within the head portion 20 forming the shower head, and the sintered magnetic body corresponding to the parent body of the delivery side antibacterial material 10 can be increased in size. Accordingly, the delivery side antibacterial material 10 acts on the mixed water immediately before being delivered, thereby applying the disinfecting effect to the fungus coming from the delivery side. Therefore, it is possible to prevent the saprophytic bacteria within the combination tap 2 and the water purifier 3 from breeding, it is possible to increase the purifying function and a swill at the beginning of use is not required.

The partition plate 30 provided in the downstream side of the delivery side antibacterial material 10 is structured such that a short cylindrical annular member is provided in an outer peripheral edge in each surface side of a disc in a protruding manner, a fitting hole to which the collecting and passing member 30a for changing to the inlet portion toward the shower delivery side or the straight delivery side is fitted and attached is perforated in a center portion of the disc-like partition plate 30, and an annular rib is provided in an outer peripheral side of the fitting hole perforating position in the partition plate 30 in a protruding manner. Then, in the annular member in the outer peripheral edge, a male screw is formed on an outer peripheral surface, whereby the shower plate 40 can be combined.

The collecting and passing member 30a provided in the center portion of the partition plate 30 is formed in a flanged columnar shape shallowly engraved an end surface in the flange side so as to form a flat surface shape with an outer edge. An annular groove is inscribed in the column portion deep in an axial direction at a degree of not-penetrating from the end surface in the flange side. A lot of light shafts in which outer leading end portions reach the flange portion are inscribed in an outer periphery of the annular groove. An outer diameter of the column portion provided with the annular groove having the light shafts is made smaller than an outer diameter of the flange portion. A lower end portion in an outer side of the light shafts is formed in a shape open sideward. The collecting and passing member 30a is structured such that an outer size of the column portion and the flange portion has an outer diameter capable of being fitted to the fitting hole in the partition member 30, and an axial size is regulated so that an opening formed on a side surface of the column portion reaches a position of a downwardly compressed hole formed in the fitting hole of the partition member 30, thereby flowing out the raw water or the purified water which flows out downward in a diametrical direction from the opening by the compressed hole so as to be concentrated into the lower side of the center portion.

The shower plate 40 forms a flat disc portion and a protruding portion formed by rising up an outer peripheral edge thereof. The shower plate 40 is structured such that the straight delivery port 31 is perforated in a center portion of the disc portion, an axial hole passing the axis of the delivery switching valve 50 therethrough so as to axially support is perforated in adjacent to the straight delivery port 31, and a lot of small holes forming the shower delivery ports 32 are perforated with an approximately uniform interval in a periphery of the straight delivery port 31 on the surface except the straight delivery port 31 and the axial hole.

The shower plate 40 sets the protruding portion forming side of the disc portion having the respective holes perforated to an inflow side (an upstream side) of the mixed water, and a female screw is formed in an inner peripheral surface side of the protruding portion, thereby being combined with the male screw provided in the partition member 30. Further, the straight delivery passage 33 is provided in the upper portion of the straight delivery port 31 in a standing manner, whereby it is possible to section the inner side of the straight delivery passage 33 and the shower delivery passage 34. Furthermore, two protruding portions 40a and 40a are provided in a protruding manner in an outer peripheral side of the position having the axial hole, on the outer peripheral surface of the protruding portion in such a manner as to hold the outer peripheral surface at the axial hole perforating position. Accordingly, the structure is made such that when the switching lever 52 is provided between two protruding portions 40a and 40a, the operating range of the switching lever 52 can be regulated to an angle of rotation which is given by the interval between two protruding portions 40a and 40a.

The purifying cartridge 9 which is received within the water purifier 3 is constituted, as shown in FIGS. 2 and 3, by a solid purifying material 9c having granular or fibrous active carbons as a main component, a filter 9d covering an outer peripheral surface of the solid purifying material 9c, and end covers 9e and 9f fitted and attached to respective end surfaces of a cylindrical material obtained by integrally forming the solid purifying material 9c and the filter 9d. When the mixed water filters out to an inner peripheral surface side from an outer peripheral surface side of the solid purifying material 9c via the filter 9d, floating fine solid materials are filtered and chemical compositions dissolving in the water are adsorbed. Accordingly, in the water purifier 3 receiving the purifying cartridge 9, an outer peripheral surface side flow passage of the solid purifying material 9c is used as a part of the raw water flow passage 9b, and an inner peripheral surface side flow passage of the solid purifying material 9c is used as a part of the purified water flow passage 9a. In the end covers 9e and 9f, the end cover 9e forms a top lid of the purifying cartridge 9, and the end cover 9f forms a bottom plate of the purifying cartridge 9.

A case portion of the water purifier 3 take in the purifying cartridge 9 is constituted by a case main body 3f having a closed-end cylindrical shape, and a lid 3g screwed with an upper end of the case main body and forming a closed vessel. A purified water side connection pipe 3h internally fitting a cylindrical outflow port provided in a center portion of the end cover 9e forming the top lid of the purifying cartridge 9 in a protruding manner is provided in an inner surface side of the lid 3g in a protruding manner, and a plurality of ribs 3m and 3m for mounting the purifying cartridge 9 are provided in a bottom portion of the case main body in a protruding manner.

[Operation and Effect of the First Embodiment]

In the first embodiment mentioned above, it is possible to select any one of the hot water, the water and the mixed water by turning the lever 6b of the hot water and water mixing and stop valve 6 in a vertical direction and/or a horizontal direction, it is possible to select the water quality state by pressing the push button 21a of the flow passage switching valve 21, thereby allowing to switch the delivery state between the straight delivery state and the shower delivery state by turning the switching lever 52 of the delivery switching valve 50 so as to use the water.

The hot water and water mixing and stop valve 6 generates the water stop state in which none of the hot water, the water and the mixed water is supplied, by the state in which the lever 6b is pressed down. The relative positional relationship between the fixed member 6d and the movable member 6e changes by pressing up the lever 6b so as to operate the lever 6b within the operation range, thereby generating the state in which any of the hot water, the water and the mixed water is supplied.

At first, it is assumed that there is generated the water stop state in which the lever 6b is pressed down. At this time, when fully turning the lever 6b in the counterclockwise direction and further pressing up the lever 6b, the leading end portion of the hole 12d in the movable member 6e overlaps the water flow passage 12b perforated in the fixed member 6d, so that the water flows at a corresponding water amount to the moving amount (refer to FIG. 5A). On the contrary, when fully turning the lever 6b in the clockwise direction and further pressing up the lever 6b, the leading end portion of the hole 12d in the movable member 6e overlaps the hot water flow passage 12a perforated in the fixed member 6d, so that the hot water flows at a corresponding hot water amount to the moving amount (refer to FIG. 5B). At the middle position there between, when suitably turning the lever 6b and pressing up the lever 6b, the leading end portion of the hole 12d in the movable member 6e overlaps a part of the hot water flow passage 12a and a part of the water flow passage 12b, so that the mixed water flows at a corresponding amount to the moving amount (refer to FIG. 5C).

When operating the push button 21a assembled in the head portion 20, the raw water flows out in the state in which the push button 21a protrudes from the head portion 20 (at the shallow pressing amount), and the purified water flows out in the state in which the push button 21a enters into the head portion 20 and the protruding amount is reduced (at the deep pressing amount).

First, when pressing the push button 21a in the state in which the push button 21a is at the shallow pressing amount position and the raw water flows out (FIGS. 6 to 9), the second switching piece 25c brought into contact with the push button 21a pushes the first switching piece 25b, thereby transmitting the pressing force from the first switching piece 25b to the double throw push rod 24 so as to move the double throw push rod 24 in the pressing direction against the energizing force of the coil spring 26.

At this time, when the first switching piece 25b slides in a direction moving through the groove in the switching ring 25a, a front elevation cross sectional view which shows the second embodiment.

and moves up as far as being out of the groove, the first switching piece 25b moves so as to change direction to a direction closely attaching in correspondence to the shape of the contact portion between the second switching piece 25c and the first switching piece 25b, so that the first switching piece 25b pressed by the second switching piece 25c rotates so as to change the relative position between the first switching piece 25b and the switching ring 25a, close the raw water side shutoff valve 23 (FIG. 12), open the purified water side shutoff valve 22 (FIG. 13) and switch the flow passage switching valve 21 to the purified water outflow.

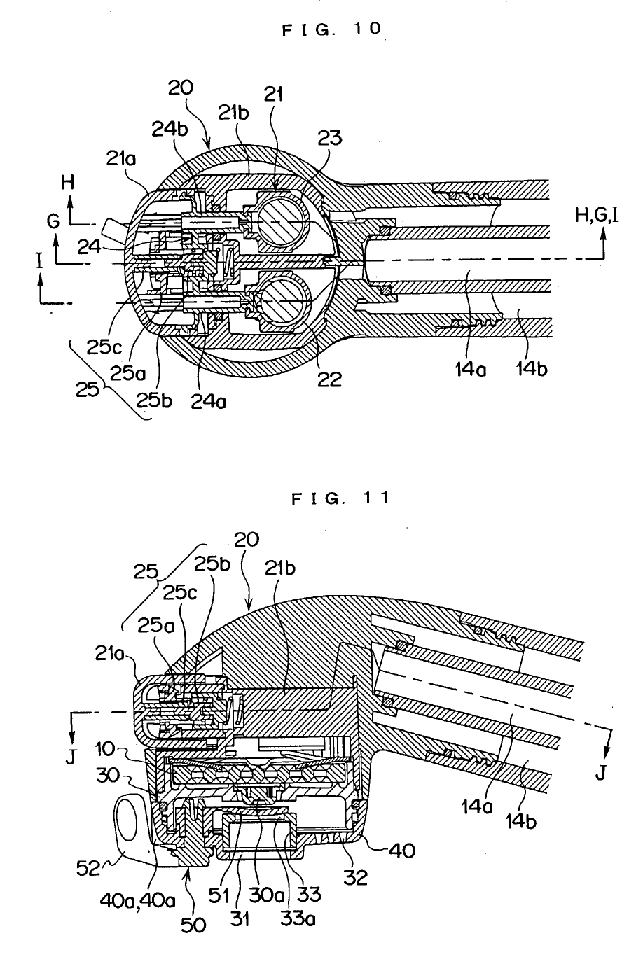

When the outflow mixed water is switched to the purified water, the first switching piece 25b moves in a returning direction at a play by an energizing force of the coil spring 26 so as to turn back the double throw push rod 24, and the end portion of the rib provided in the first switching piece 25b is brought into contact with the shallow groove side inscribed in the switching ring 25a so as to fix the position of the push button 21a to the position of the deep pressing amount (FIGS. 10 and 11).

Next, when further pressing the push button 21a in the state in which the push button 21a is at the position of the deep pressing amount and the purified water flows out (FIGS. 10 to 13), the double throw push rod 24 is moved in the pressing direction against the energizing force of the coil spring 26 by transmitting the pressing force from the second switching piece 25c brought into contact with the push button 21a to the first switching piece 25b and further to the double throw push rod 24. Accordingly, the end portion of the rib provided in the first switching piece 25b takes off the engagement with the shallow groove inscribed in the switching ring 25a, and moves so as to change the direction to the direction closely attaching in correspondence to the shape of the contact portion between the second switching piece 25c and the first switching piece 25b, so that the first switching piece 25b pressed by the second switching piece 25c rotates so as to change the relative position between the first switching piece 25b and the switching ring 25a.

Accordingly, the rib provided in the first switching piece 25b enters into the groove which is provided deep in the axial direction in the switching ring 25a, whereby the rib provided in the first switching piece 25b is slid in the pressing back direction along the groove of the switching ring 25a. Then, the double throw push rod 24 brought into contact with the first switching piece 25b is moved in the pressing back direction, the purified water side shutoff valve 22 is closed (FIG. 9), the raw water side shutoff valve 23 is opened (FIG. 8), and the flow passage switching valve 21 is switched to the outflow of the raw water. When the flowing out mixed water is switched to the raw water, the push button 21a which is turned back due to the energizing force of the coil spring 26 is fixed to the position at the shallow pressing amount (FIGS. 6 and 7).

Further, the flowing out mixed water is delivered in the straight delivery state or the shower delivery state by operating the switching lever 52 of the delivery switching valve 50 which is assembled in the delivery side of the head portion 20.

First, in the case of delivering in the shower delivery state, when operating the switching lever 52 so as to turn around the axis independently from the operation of the push button 21a, the valve body 51 comes off from the opening portion 33a of the straight delivery passage 33, and the mixed water flowing out from the collecting and passing portion 30a flows into the opening portion 33a of the straight delivery passage 33, and flows out from the straight delivery port 31.

Next, in the case of delivering in the straight delivery state, when operating the switching lever 52 in the opposite direction so as to turn reverse around the axis, the valve body 51 cover up the opening portion 33a of the straight delivery passage 33 so as to prevent the mixed water flowing out from the collecting and passing portion 30a from flowing into the opening portion 33a of the straight delivery passage 33, thereby flowing the mixed water into the shower delivery passage 34 side. Then, the mixed water flows out from the shower delivery port 32.

According to the first embodiment mentioned above, it is possible to selectively deliver any of the water, the hot water and the mixed water by the hot water and water mixing and stop valve 6, the raw water and the purified water can be delivered by the flow passage switching valve 21. Further, it is possible to select the straight delivery state or the shower delivery state by the delivery switching valve 50. Therefore, it is possible to achieve the faucet which can be variously used.

The water purifier 3 placed in; the lower portion of the hot water and water mixing and stop valve 6 is branched into the purified water flow passage 9a and the raw water flow passage 9b in the inner portion thereof. When the mixed water flows through the raw water flow passage 9b, the materials which are filtered at a time of purifying the water quality so as to be attached to the outer peripheral surface of the purifying cartridge 9 are washed out. Accordingly, the clogging can be prevented and it is possible to extend an effective service life of the purifying cartridge 9.

Since the flow passage switching valve 21 for switching the water quality is assembled in the head portion 20, the limit in size of the flow passage switching valve 21 is reduced. Further, the flow passage switching valve 21 can be operated in the side of the head portion 20, so that an operability can be improved, whereby it is possible to achieve an easily handling shape and structure. The flow passage switching valve 21 is structured as an alternating switching shutoff valve in which the raw water shutoff valve 23 and the purified water shutoff valve 22 alternately shut off the flow passage by the same push button 21a. This allows to switch the purified water and the raw water so as to use by pressing the push button 21 protruding to the head portion 20, thereby capable of forming a switching valve having an improved operability.

Further, the raw water shutoff valve 23 and the purified water shutoff valve 22 in the alternating switching shutoff valve are respectively constituted by the spherical valve bodies 23b and 22b. Therefore, the water pressure applied to the spherical valve bodies 23b and 22b act on the spherical valve bodies 23b and 22b together with the energizing force of the coil springs 23d and 22d in such a manner as to press the spherical valve bodies 23b and 22b to the valve seats 23a and 22a, at a time of closing the valve. Accordingly, it is possible to securely seal and it is possible to form the shutoff valve having an improved sealing performance.

Providing the delivery side antibacterial material 10 in the downstream side of the flow passage switching valve 21 makes it possible to disinfect or sterilize the saprophytic bacteria within the purifying cartridge 9. Further, even when the saprophytic bacteria enters from the delivery side, it is possible to inhibit the saprophytic bacteria from breeding and to increase the purifying function.

Since the delivery switching valve 50 is formed in the shutoff valve in accordance with the lever operation, the shower delivery state and the straight delivery state can be selected in both cases of the raw water delivery state and the purified water delivery state, thereby improving a convenience.

The branch port 11 is provided, so that it is possible to supply a necessary amount of hot water or water to the other equipment such as the dish washing machine or the like via the branch port 11.

[Second Embodiment]

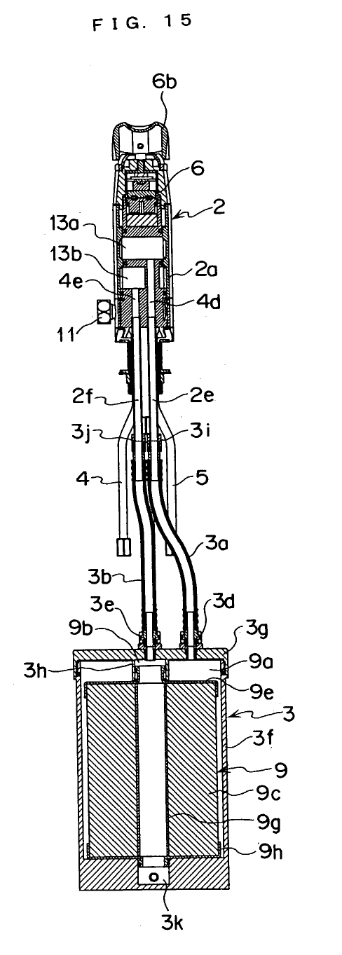

The combination tap with the external water purifier according to the first embodiment is constructed such that outer peripheral portion of the purifying material in the internal flow passage of the water purifier is formed as the raw water flow passage. However, a combination tap with an external water purifier according to a second embodiment is different from the first embodiment in a point that the inner peripheral portion of the purifying material in the internal flow passage of the water purifier is formed as the raw water flow passage as shown in FIG. 14 to FIG. 15.

In the following description, the individual members other than the members relating to the construction of the flow passage are made in the same construction as that of the first embodiment, and the same reference numerals are attached to the same members as the members in the first embodiment and a description thereof will be omitted.

[Construction]

The water purifier 3 purifying the mixed water is arranged below the main body 2a of the combination tap 2, the pipe 4 exclusive for the hot water and the pipe 5 exclusive for the water are trailed, and upper end portions of the pipes 4 and 5 are respectively connected to the inflow sides of the hot water and water mixing and stop valve 6. A connection portion 6f in an outflow side of the mixed water is connected to a connection portion 3c in an inflow side of the water purifier 3 by the pipe 6a exclusive for the mixed water. A connection portion 3d in a purified water outflow side of the water purifier 3 is connected to a connection portion 3i of a flow passage which is communicated with a purified water inflow side of the flow passage switching valve 21 assembled in the outflow end portion 2c of the main body 2a by the purified water pipe 3a. A connection portion 3e in a raw water outflow side of the water purifier 3 is connected to a connection portion 3j of a flow passage which is communicated with a raw water inflow side of the flow passage switching valve 21 by the raw water pipe 3b. The delivery side antibacterial material 10 for preventing the saprophytic bacteria from breeding is arranged in an outlet port of the flow passage switching valve 21, and an outflow side of the flow passage switching valve 21 is connected to an inflow side of the delivery switching valve 50 via an installing portion of the delivery side antibacterial material 10.

In an inner portion of the water purifier 3, as shown in FIGS. 14 and 15, there is formed from the connection portion 3c in the inflow side to which the pipe 6a is connected, a purified water flow passage 9a which passes through the purifying cartridge 9 from a center portion toward an outer peripheral side, purifies the water quality and flows out to the external portion of the water purifier 3 from the connection portion 3d in the purified water outflow side formed in the outer peripheral side of the purifying cartridge 9 in one side, and a raw water flow passage 9b which passes through a center portion of the purifying cartridge 9 and flows out from the connection portion 3e in the raw water outflow side formed in the center portion side of the purifying cartridge 9 to the external portion of the water purifier 3, thereby forming a purified water and raw water branching passage.

The purified water pipe 3a and the raw water pipe 3b from the water purifier 3 are respectively connected to the connection portions 3i and 3j of the connection pipes 2e and 2f which are independently provided in the lower end of the main body 2a, and are communicated with the purified water flow passage 4d and the raw water flow passage 4e within the main body 2a of the combination tap 2.

The flow passage within the main body 2a of the combination tap 2 is formed by arranging a purified water side space 13a connected to the purified water flow passage 4d and a raw water side space 13b connected to the raw water flow passage 4e in an axial direction, and is communicated with each of a purified water flow passage 14a of an inner flow passage and a raw water flow passage 14b of an outer flow passage which are formed in an inner portion of the outflow end portion 2c formed as a double tube from the respective spaces 13a and 13b.

The purifying cartridge 9 which is received within the water purifier 3 is constituted by a solid purifying material 9c having granular or fibrous active carbons as a main component and formed in a cylindrical shape, a filter 9g covering an inner peripheral surface of the solid purifying material 9c, and end covers 9e and 9h fitted and attached to respective end surfaces of a cylindrical material obtained by integrally forming the solid purifying material 9c and the filter 9g. When the mixed water filters out to an outer peripheral surface side from an inner peripheral surface side of the solid purifying material 9c via the filter 9g, floating fine solid materials are filtered and chemical compositions dissolving in the water are adsorbed. Accordingly, in the water purifier 3 take in the purifying cartridge 9, an inner peripheral surface side flow passage of the solid purifying material 9c is used as a part of the raw water flow passage 9b, and an outer peripheral surface side flow passage of the solid purifying material 9c is used as a part of the purified water flow passage 9a. In the end covers 9e and 9h, the end cover 9e forms a top lid of the purifying cartridge 9, and the end cover 9h forms a bottom plate of the purifying cartridge 9.

A case of the water purifier 3 receiving the purifying cartridge 9 is constituted by a case main body 3f having a closed-end cylindrical shape, and a lid 3g screwed with an upper end of the case main body 3f and forming a closed vessel. A purified water side connection pipe 3h internally fitting a cylindrical outflow port provided in a center portion of the end cover 9e forming the top lid of the purifying cartridge 9 in a protruding manner is provided in an inner surface side of the lid 3g in a protruding manner, a cylindrical inflow port provided in a center portion of the end cover 9h forming a lower lid of the purifying cartridge 9 in a protruding manner is inward fitted to the bottom portion of the case main body 3f, and a hole 3k communicated with the inflow side connection portion 3c is perforated.

[Operation and Effect of the Second Embodiment]

In the second embodiment mentioned above, the construction is different from the first embodiment only in the following points. That is, the shape of the bottom portion in the case main body 3f of the water purifier 3 is changed, and the positions of the raw water outflow side connection portion 3e provided in the center portion of the lid 3g in the water purifier 3 and the purified water outflow side connection portion 3d provided in the peripheral side thereof are counterchanged. Then, in the connection of the pipes, the connection positions of the purified water pipe 3a and the raw water pipe 3b are only counterchanged with respect to the case of the first embodiment, and the other portions are not changed. Accordingly, it is possible to change the first embodiment to the second embodiment only by replacing the water purifier 3, and also possible to easily change between the first embodiment and the second embodiment only by replacing the whole of the water purifier 3 at a time of replacing the purifying cartridge 9.

Further, when the interior portion of the water purifier 3 is branched into the purified water flow passage 9a and the raw water flow passage 9b, and the mixed water flows through the raw water flow passage 9b formed as the inner peripheral surface side flow passage of the purifying cartridge 9, the materials which are filtered at a time of purifying the water quality and attached to the inner peripheral surface of the purifying cartridge 9 are washed out, the clogging can be prevented and it is possible to extend the effective service life of the purifying cartridge 9.

INDUSTRIAL APPLICABILITY

As mentioned above, the combination tap with the external water purifier according to the present invention is suitable for being used as the combination tap which is used in the kitchen or the cuisine, can purify the mixed water having an optionally set temperature, can remove the limit in size of the water purifier, can wash away the contamination accumulated within the water purifier at a time of delivering the raw water, and can prevent the breeding of saprophytic bacteria.

1. (Amended) A combination tap with an external water purifier comprising:
a water mixing and stop valve which mixes hot water and water and forms a main cock;
a water purifier which is arranged in a downstream side of the water mixing and stop valve and in an external portion of the combination tap so as to purify raw water, and has flow passages for purified water and the raw water;
a water quality switching valve which is arranged in a downstream side of the water purifier and flows out any one of the purified water and the raw water to a delivery side; and
a purifier surface from which the raw water goes into the purifying material at a time of using the purified water as a part of the raw water flow passage at a time of using the raw water.

2. (Amended) A combination tap with an external water purifier according to claim 1, wherein a delivery side antibacterial material is provided in a downstream side of said water quality switching valve.

3. (Amended) A combination tap with an external water purifier according to claim 1, further comprising a delivery switching valve which is arranged in a downstream side of said water quality switching valve and switches a delivery state to a shower delivery state and a straight delivery state.

4. (Amended) A combination tap with an external water purifier according to any one of claims 1 or 2, wherein a branch port into the other equipment is provided in a lower end portion of a main body in said water mixing and stop valve.

5. (Amended) A combination tap with an external water purifier according to any one of claims 1 to 3, wherein said water quality switching valve is constituted by a flow passage switching valve having a push-button operation part.

6. (Amended) A combination tap with an external water purifier according to any one of claims 1 to 4, wherein said delivery switching valve is constituted by a delivery switching valve having a lever-type operation portion.

7. (Amended) A combination tap with an external water purifier according to any one of claims 1 to 5, wherein said delivery side antibacterial material is constituted by a sintered magnetic material provided with an amorphous membrane layer on a surface thereof.

8. (Deleted)
